(19) United States
(12) Patent Application Publication
(10) Pub. No.: US 2011/0153082 A1
(43) Pub. Date: Jun. 23, 2011

(54) SENSOR SYSTEM FOR DETECTING THE SURFACE STRUCTURES OF SEVERAL PACKAGED ARTICLES

(75) Inventors: Hermann Franck, Ritterhude (DE); Wolfgang Echelmeyer, Osterholz-Scharmbeck (DE); Ralf Beesner, Bremen (DE); Eckhard Wellbrock, Bremen (DE)

(73) Assignee: Deutsche Post AG, Bonn (DE)

(21) Appl. No.: 12/973,102

(22) Filed: Dec. 20, 2010

(30) Foreign Application Priority Data
Dec. 23, 2009 (DE) 102009060551.7-54

(51) Int. Cl. B25J 13/08; G01C 3/00; G01B 11/24; G01B 11/14

(52) U.S. Cl. 700/259; 356/3.1; 901/9; 901/31

(57) ABSTRACT

An exemplary embodiment of the invention relates to a sensor system for detecting the surface structures of several packaged articles. An exemplary system comprises at least one laser distance detector that functions according to a triangulation principle and that determines the distance between the laser distance detector and a surface structure of a packaged article. The laser distance detector has at least one analog output via which a distance-proportional analog signal can be emitted. The analog output of at least one laser distance detector is in communication with an evaluation unit via an amplifier circuit. The amplifier circuit encompasses at least one operational amplifier that has two inputs, and the analog signal of the laser distance detector is present at a first input of the at least one operational amplifier. A variable reference voltage is present at the other input of the at least one operational amplifier. The reference voltage may be obtained from the analog signal of the analog output, and this analog signal may be present at the other input of the operational amplifier via a low-pass filter. The output of the at least one operational amplifier may be connected to the evaluation unit, as a result of which the amplifier circuit is configured in such a way that abrupt changes in the analog signal bring about a change in the output signal of the at least one operational amplifier. More gradual changes in the analog signal do not bring about a substantial change in the output signal of the at least one operational amplifier. The evaluation unit may evaluate the output signal of the at least one operational amplifier.

### CROSS REFERENCE TO RELATED APPLICATION

This application claims priority to German (DE) Patent Application No. 10 2009 060 551.7-54, filed on Dec. 23, 2009, the contents of which are incorporated by reference as if set forth in their entirety herein.

### BACKGROUND

Many packaged articles such as parcels, cartons or other packaged goods are transported and transferred in the realm of logistics centers and distribution hubs such as, for instance, airports, postal and freight transshipment centers or commissioning centers. The transfer of these packaged articles, for instance, between two positions, is being increasingly automated so that these procedures can be simplified for the personnel and made altogether faster. Here, robots are typically used that pick up and transfer one or more packaged articles. The packaged articles, however, often do not have a uniform size, shape or surface structure, which has to be taken into account for controlling the robot and which often cannot be solved at all or else only with complex sensor technology.

In this context, transfer processes that make automation desirable can be carried out at the various transshipment stations. For example, this is the case when cartons, parcels, books, catalogs, etc. are unloaded from pallets. In this process, a robot has to remove and transfer several layers of such packaged articles from the pallet, whereby, on the one hand, there can be differently sized goods or differently arranged goods in one layer. Consequently, a robot cannot pick up and transfer packaged articles from such a pallet according to a fixed routine, but rather, if all of the goods have to be transferred individually, there is a need for sensor technology in order to detect each packaged article. Only in this manner is it possible to individually detect, pick up and transfer each individual packaged article one at a time.

When packaged articles are unloaded from pallets, the additional problem arises that pallets containing small-sized goods are often shrink-wrapped with a plastic film for stabilization purposes. In order to prevent this packaging unit from falling apart already before being shrink-wrapped, especially in the case of catalogs and flat cartons, the stacking pattern is changed every 5 to 10 layers and a paper interlayer is inserted. These paper interlayers, however, hinder the automated unloading of the pallet since they would detrimentally affect the handling process. For this reason, they have to be segregated, which means that, in the case of an automated process, they first have to be detected.

Another transshipment station includes the unloading of a container or of a swap body that is parked in front of the loading dock of a building, where it is unloaded. If the container is loaded with individual cartons, parcels, packaged goods, etc., they are normally stacked on top of each other inside the container and are then removed from the top of the stack by a person and subsequently placed, for example, onto a conveyor belt outside of the container. In order to simplify and speed up this procedure, German patent application DE 10 2005 047 644 A1 discloses a robot that can be driven through the loading opening into a container that is to be emptied. The robot is facing the front row of the load in the container in the form of a vertical stack including several packaged articles of different sizes and shapes, whereby the robot has to be equipped with sensor technology capable of detecting and locating individual packaged articles in the stack so that the packaged article in question can be picked up by a gripping system of the robot and transferred to a conveyor belt. Suitable gripping systems for picking up packaged articles from a vertical stack are disclosed in German patent applications DE 10 2006 022 278 A1 and DE 10 2006 022 277 A1.

Consequently, in order for robots to be able to automatically transfer packaged articles one at a time from pallets as well as out of containers, there is normally a need for sensor technology that is capable of detecting different surface properties of goods within a stack of packaged articles or within a layer of packaged articles. For this purpose, solutions involving cameras having evaluation software are known with which the contours and/or surface characteristics of individual packaged articles can be ascertained. Solutions involving cameras, however, are relatively expensive and also make considerable demands of the operating environment since, for instance, they are sensitive to extraneous light and to shadows. Particularly in the case of catalog pallets, misprints are sometimes used as the paper interlayers, so that the paper interlayers are difficult to optically distinguish from the catalogs. Consequently, solutions involving cameras would not be able to recognize such paper interlayers.

Moreover, it is possible to employ a 3D laser scanner and an image processing device to detect the upper edge, for example, of a stack of packaged articles. Generally speaking, this information is sufficient since the robot can be constructed in such a way that it orients the gripping procedure relative to the upper edge of the packaged articles. In some cases, however, it can also be necessary to have information about the lower edge of a packaged article in a stack. This is the case, for instance, when goods have been stacked floor-to-ceiling in a container and the uppermost packaged article has to be gripped by the lower edge.

Therefore, in order for the lower edges to be detected as well, it is necessary to provide sensor technology that can detect the gaps between the packaged articles. Such sensor technology could also be deployed to detect paper inter-layers on pallets since, by evaluating corresponding signals, it could detect the difference between a layer of packaged articles with several gaps and continuous cardboard without gaps.

In this context, it has to be taken into consideration that the packaged articles to be handled such as parcels, cartons, packaging, etc. are often soft, so that a stack does not stand precisely upright. Moreover, the packaged articles are not stacked precisely one above the other and the surfaces can be dented, slightly wavy or else have other irregularities such as adhesive tape and/or stickers.

When a stack or a layer of packaged articles is scanned by a sensor during a scanning pass in order to detect gaps between the packaged articles, the sensor—during its scanning pass—will find a contour that does not run exactly parallel to the trajectory of the robot. Rather, there are several irregularities in the contour, whereby the sensor system has to be able to distinguish gaps between the packaged articles from irregularities on the surface of the packaged articles.

### SUMMARY

A sensor system according to an exemplary embodiment of the invention can be employed especially in the realm of logistics centers and distribution hubs in order to detect the surface structures of packaged articles, whereby the information thus obtained can be further processed for various purposes. Exemplary embodiments relate to a sensor system for detecting the surface structures of several packaged articles, comprising at least one laser distance detector that functions according to the triangulation principle and that determines the distance between the laser distance detector and a surface structure of a packaged article, whereby the laser distance detector has at least one analog output via which a distance-proportional analog signal can be emitted.

One exemplary embodiment of a sensor system is as simple as possible and can distinguish gaps between packaged articles and edges of packaged articles from irregularities on the surface of the packaged articles.

A sensor system according to an exemplary embodiment of the invention detects the surface structures of several packaged articles. Such an exemplary sensor system comprises at least one laser distance detector that operates according to the triangulation principle and that determines the distance between the laser distance detector and a surface structure of a packaged article. In this context, the laser distance detector comprises at least one analog output via which a distance-proportional analog signal can be emitted. This analog output of the at least one laser distance detector is in communication with an evaluation unit via an amplifier circuit, whereby the amplifier circuit encompasses at least one operational amplifier that has two inputs. The analog signal of the laser distance detector is present at a first input of the at least one operational amplifier, while a variable reference voltage is present at the other input of the at least one operational amplifier. The reference voltage may be obtained from the analog signal of the analog output. This analog signal may be present at the other input of the operational amplifier via a low-pass filter. The output of the at least one operational amplifier is connected to the evaluation unit, as a result of which the amplifier circuit is configured in such a way that abrupt changes in the analog signal bring about a change in the output signal of the at least one operational amplifier. In contrast, relatively gradual changes in the analog signal do not bring about any substantial change in the output signal of the at least one operational amplifier. The evaluation unit may evaluate the output signal of the at least one operational amplifier.

When the sensor system according to an exemplary embodiment of the invention scans the surface structure of several packaged articles, the distance between the laser distance sensor and the surface of the object in question is continuously detected. Owing to the amplifier circuit, the connected evaluation unit is capable of distinguishing abrupt distance changes from more gradual distance changes. For instance, the evaluation unit can then conclude that abrupt distance changes are gaps between two packaged articles, or else edges of a packaged article, whereas more gradual distance changes are considered to be other surface structures of the scanned packaged article.

In order to be able to detect increases in distance as well as decreases in distance, the amplifier circuit can comprise two operational amplifiers, whereby the first operational amplifier and the second operational amplifier are connected in parallel. The analog signal of the at least one laser distance detector is then present at the first input of the first operational amplifier and at the first input of the second operational amplifier, whereas the variable reference voltage is present at the other input of the first operational amplifier and at the other input of the second operational amplifier. The outputs of the two operational amplifiers may be connected to the evaluation unit via an OR gate, so that the evaluation unit can detect a change-over in the output signal of the first operational amplifier as well as in the output signal of the second operational amplifier.

In an exemplary embodiment, a virtual zero point of the amplifier circuit is raised in such a way that the amplifier circuit operates in a voltage range that differs from that of the at least one laser distance detector. In this manner, the amplifier circuit can operate in a range that is favorable for it, even though the laser distance detector supplies a different voltage.

In an exemplary embodiment of the invention, the sensor system is installed on the gripping tool of a robot that moves the sensor system along the surface of several packaged articles. The sensor system may be in communication with a robot control unit that evaluates the output signals of the amplifier circuit and controls the robot. Therefore, the robot can be employed to move one or more laser distance detectors along the surface of several packaged articles in order to determine the surface structure of the packaged articles or the distances between several packaged articles during a scanning pass. The results of this distance measurement can then be used by the control unit of the robot to control the gripping tool of the robot in such a way that, for instance, individual packaged articles can be gripped and transferred. The information thus obtained, however, can also be utilized for any other systematic actuation of the robot.

In one exemplary embodiment of the invention, the sensor system is installed, for example, on the gripping tool of a pallet-unloading robot, and it comprises several laser distance sensors. Since packaged articles are stacked in several layers on pallets and are normally gripped from above, the control unit of the robot may be configured to move the sensor system in a horizontal plane along the surface of at least one packaged article for purposes of scanning the top layer of a pallet in each case. In this manner, the structure of the top pallet layer can be detected and the robot can be appropriately actuated in order to, for example, grip and transfer individual packaged articles from this layer.

In another exemplary embodiment of a pallet-unloading robot, the sensor system may be used to recognize and segregate paper interlayers. If no abrupt distance changes but rather, for instance, only more gradual distance changes caused by waviness in a paper interlayer are detected in a layer of packaged articles during a scanning pass, this can be considered to be a paper interlayer. Paper interlayers thus recognized can then be gripped by the gripping tool and can be systematically segregated.

In order to be able to evaluate the scanning pass carried out by several laser distance sensors and to thus recognize paper interlayers on which there are no more packaged articles, the control unit of the robot may comprise a memory unit in one exemplary embodiment of the invention. Each analog output of a laser distance sensor may be connected to this memory unit via an amplifier circuit. The memory unit encompasses several RS flip-flops and each output signal of an amplifier circuit is present at an individual RS flip-flop. When a signal occurs, the appertaining flip-flop is set. The outputs of the RS flip-flops are linked to each other via an AND gate that supplies a defined value when all of the flip-flops are set, whereby the defined value can be evaluated by the control unit of the pallet-unloading robot. When all of the flip-flops are set, this means that each sensor has detected an abrupt distance change during its scanning pass. This causes a layer to be recognized as a paper interlayer after a scanning pass when the AND gate does not supply the defined value, since this means that not all of the sensors have responded and thus not all of the flip-flops were set. The control unit of the robot may also comprise a reset circuit that resets the RS flip-flops so that the flip-flops can be reset before each new scanning pass.

If there is a need to absolutely prevent paper interlayers from reaching the conveying system, only complete layers for which all of the sensors have responded may be placed onto the conveying system, while everything else is treated as a paper interlayer. The control unit of the robot then may be adapted to place a paper interlayer at a defined position when the AND gate does not supply the defined value. In this manner, paper interlayers can be segregated once they have been detected.

In another exemplary embodiment of the invention, the sensor system may be installed on the gripping tool of a parcel robot, whereby the control unit of the parcel robot moves the sensor system in a vertical plane along the surface of several parcels in a stack. Thus, at least one laser distance detector can be moved vertically on a stack of packaged articles such as parcels in order to detect gaps between the parcels or edges of parcels. The control unit of the robot can utilize this information to determine the contours of parcels, for instance, so that it can grip and transfer individual parcels. In this context, the sensor system, in addition to at least one 3D laser scanner and an image processing device, can be installed on a parcel robot, whereby the control unit of the robot selects the sensor system and the 3D laser scanner, as needed. In this manner, the sensor system according to an exemplary embodiment of the invention can be used when a 3D laser scanner along with an image processing device is not sufficient to acquire the requisite information about the surface structure of a stack of parcels.

In another exemplary embodiment of the invention, the sensor system may be installed above or to the side of a conveyor line for packaged articles, whereby the conveyor line comprises at least two separately driven segments. The sensor system may detect the surfaces of the packaged article being transported past and thus ascertains gaps between the packaged articles. The exemplary sensor system is in communication with a control unit of the conveyor line with which the speed of the segments can be controlled separately, and when an evaluation unit detects a gap between two packaged articles that is too small, the speed of the at least two segments of the conveyor line can be varied in such a way that the two packaged articles are individuated.

A sensor system according to an exemplary embodiment of the invention allows the surface structure of several packaged articles to be detected more precisely than it has been the case with the devices known so far, whereby the focus lies on abrupt distance changes that can be considered to be gaps between two packaged articles or edges of a packaged article. More gradual distance changes that merely indicate irregularities on the surface of the object in question are ignored.

Moreover, the sensor system according to an exemplary embodiment of the invention is very sturdy and can be used irrespective of the ambient conditions. In contrast to complex solutions involving cameras, it is also more cost-effective and its basic principle can be flexibly employed in various areas of application in the realm of logistics and distribution.

### BRIEF DESCRIPTION OF THE DRAWINGS

Additional advantages, special features and practical refinements of the invention ensue from the subordinate claims and from the presentation below of exemplary embodiments on the basis of the figures.

FIG. 1 is a diagram showing a mode of operation of a distance-measuring device according to an exemplary embodiment of the present invention;

FIG. 2 is a schematic diagram of a floating-point comparator having one operational amplifier for measuring increases in distance according to an exemplary embodiment of the present invention;

FIG. 3 is a schematic diagram of a floating-point comparator having two operational amplifiers for measuring increases and decreases in distance, and having an OR gate according to an exemplary embodiment of the present invention;

FIG. 4 a schematic diagram of a floating-point comparator having an operational amplifier and with a rise in the virtual zero point according to an exemplary embodiment of the present invention;

FIG. 5 is a cross-sectional side view of a first embodiment of a sensor system according to an exemplary embodiment of the present invention, with the detection of packaged articles in a stack of parcels;

FIG. 6 is a series of perspective views showing a second embodiment of a sensor system according to an exemplary embodiment of the present invention, with the detection of a paper interlayer on a pallet, depicting situations a) through c);

FIG. 7 is a schematic diagram of a circuit for implementing the exemplary embodiment shown in FIG. 6;

FIG. 8 is a side view showing a third embodiment of a sensor system according to an exemplary embodiment of the present invention, with the detection of distances between packaged articles on a conveyor belt.

### DETAILED DESCRIPTION OF SPECIFIC EMBODIMENTS

Exemplary embodiments of the invention make use of distance sensors operating according to the triangulation principle of the type known in industrial sensor technology and also referred to as diffuse reflection sensors for measuring tasks or as displacement sensors. Such distance sensors can be used to detect small distances ranging from 50 mm to 800 mm, whereby these devices trigger programmed control procedures when the value rises above or falls below a defined distance. The switching threshold and switching hysteresis can be permanently programmed here.

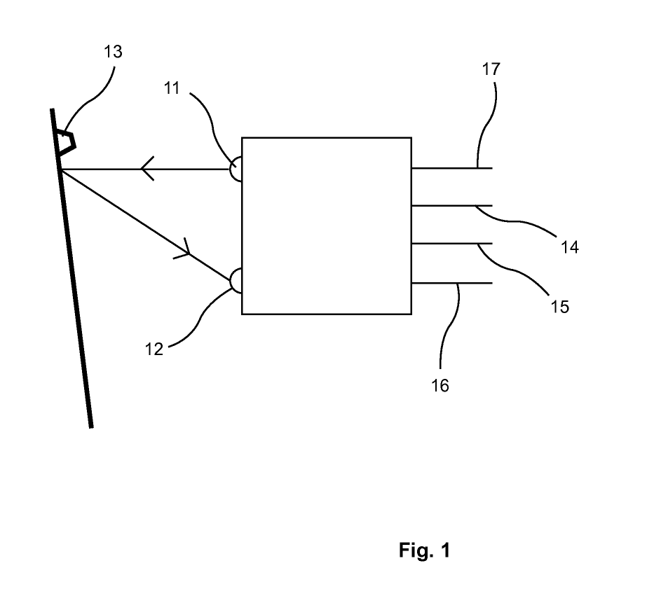

FIG. 1 schematically shows such a distance-measuring device 10 at which an operating voltage 17 is present and to which a ground 16 is connected. In order to measure a distance, a transmitter 11 of the device 10 emits a laser beam that is backscattered from a struck object 13, which is indicated by arrows in FIG. 1. Some of the backscattered laser light is directed by a lens system onto a receiver 12 in the form of a photo diode array. Depending on the angle of incidence, different diodes are struck in this photo diode array. An internal microcontroller of the device 10 uses this information to calculate the distance of the reflecting object 13.

Some of such distance-measuring devices have not only a switching output 14 but also an analog output 15 that emits a distance-proportional voltage or a distance-proportional current (0 . . . 10 V or 4 . . . 20 mA). Additional devices evaluate this output signal, thus allowing other uses. For instance, two laser distance sensors can perform a thickness measurement.

If such distance sensors are employed for the above-mentioned tasks in the realm of logistics and/or distribution, they have to be capable of distinguishing the typical abrupt but very small distance changes at the boundary between two packaged articles from other distance changes. The evaluation electronics installed in commercially available distance sensors and having fixed switching thresholds as well as a fixed sensitivity level, however, have proven to be unsuitable for the envisaged objective described herein. As described herein, the evaluation electronics of an exemplary distance sensor have therefore been changed.

The switching output 14 of a distance sensor 10 with its fixed switching threshold is not utilized here. The analog signal of the analog output 15, in contrast, is evaluated by an external evaluation circuit or amplifier circuit with operational amplifiers. This circuit separates the sought small, abrupt voltage changes from the subordinate, more gradual voltage changes.

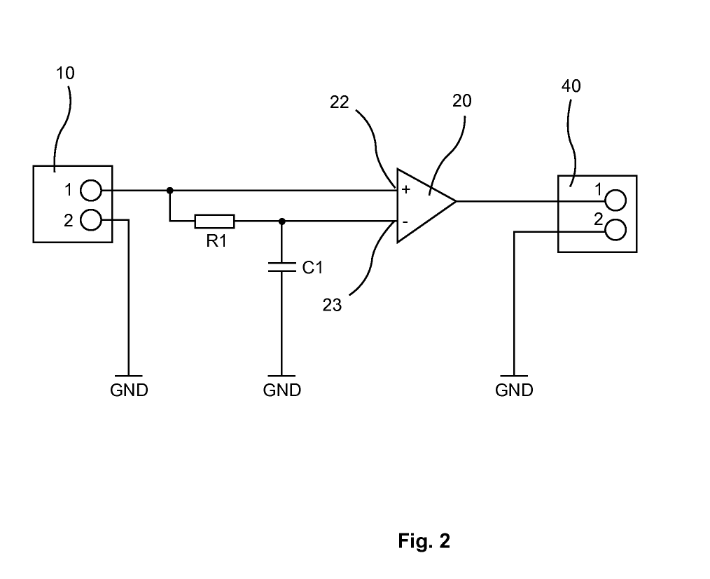

Examples of such evaluation circuits are, for instance, high-pass filters whose main component is preferably an operational amplifier that is wired as a floating-point comparator. Such a circuit is schematically shown in FIG. 2, whereby the evaluation circuit is connected downstream from the distance sensor 10. The operational amplifier 20 used has two inputs 22 and 23, which are a non-inverting input 22 and an inverting input 23. The voltage differential present between these inputs is amplified by a factor of approximately 100,000, so that already at the smallest voltage differentials, the output of the operational amplifier 20 switches over to logical “0” (e.g. −12 V) or logical “1” (e.g. 12 V), which can be detected and evaluated by an evaluation unit 40 connected to the operational amplifier.

If the analog output signal of a distance sensor 10 is applied to the non-inverting input 22 of the comparator 20, and if a fixed reference voltage is applied to the inverting input 23, then the output of the comparator 20 switches over when the reference voltage is exceeded. Instead of a fixed reference voltage, however, it is also possible to employ a variable reference voltage that is likewise obtained via a low-pass filter from the output signal of the distance sensor 10. In the embodiment of FIG. 2, the low-pass filter is formed by the resistor R1 and the capacitor C1.

Owing to the described circuit with a low-pass filter, gradual changes in the sensor signal remain without effect, while fast changes lead to a voltage differential between the two inputs 22 and 23 of the comparator 20 and allow it to switch over briefly until the signals at the two ends have equalized. The evaluation unit 40 can utilize this switch-over as an indication that an abrupt distance change, that is to say, a gap between two packaged articles, has been detected here, which, in turn, can be utilized by evaluation software in order to determine the contours of packaged articles.

The response sensitivity can be influenced in an embodiment not shown in FIG. 2 in that one of the two inputs 22 or 23 is “biased”, in other words, the potential is shifted somewhat via an adjustable resistor in the potential.

The described circuit according to FIG. 2 responds to abrupt distance changes and thus lends itself well for use in areas where a gap has formed between two packaged articles. This is the case, for example, in the upper section of a stack of lightweight packaged articles or when packaged articles are arranged next to each other on a pallet. In the case of heavy packaged articles or in the lower section of a stack, however, articles can be compressed to such an extent that there is no gap, but rather, the articles are only minimally shifted with respect to each other.

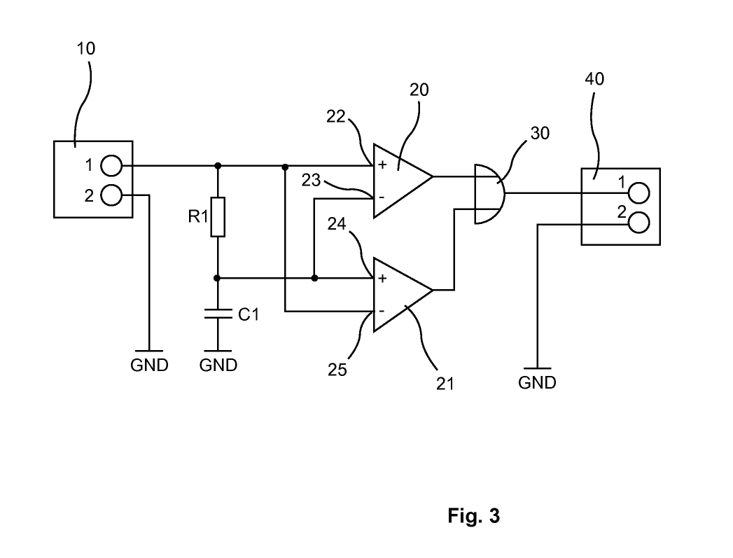

Since distance jumps can occur in both directions here, the circuit in one exemplary embodiment of the invention can be augmented by a second operational amplifier 21 connected in parallel, as is schematically shown in FIG. 3. A low-pass filter in the form of the resistor R1 and the capacitor C1 is provided here as well. The second operational amplifier 21 likewise has two inputs 24 (non-inverting) and 25 (inverting), and it responds to decreases in distance. The analog signal in this second operational amplifier 21 is present at the input 25 while the variable reference voltage is present at the other input 24. Before the signals of the first operational amplifier 20 and of the second operational amplifier 21 reach the evaluation unit 40, they are linked via an OR gate 30 located downstream.

Another conceivable circuit detail is the production of a virtual zero point, which translates into a configuration requiring fewer components. Operational amplifiers normally require a symmetrical operating voltage of about ±6 V . . . 15 V. The standard voltage in industrial control units, however, is 24 V/non-symmetrical. This problem can be solved by producing a virtual zero point at +12 V for the operational amplifier(s), as a result of which the circuit can be operated with 0 V/24 V.

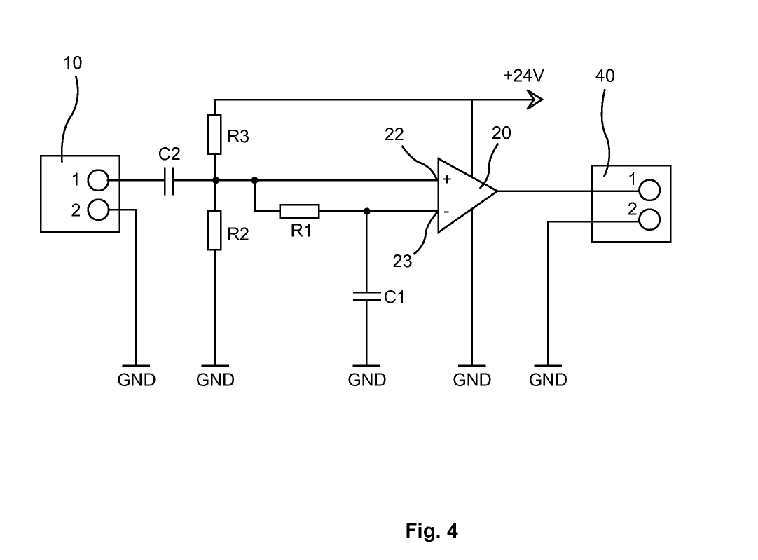

However, operational amplifiers work best around the (here virtual) zero point, and they fail close to the operating voltages (here under 2 V and above 22 V). The distance sensors, however, supply 0 V . . . 10 V. Since the absolute value is not the crucial aspect here but rather the changes in this signal, a capacitor is employed for electrical isolation in one exemplary embodiment of the invention. Such an exemplary embodiment is shown in FIG. 4 for an embodiment having only one operational amplifier 20. The resistors R2 and R3 here bring about an increase in the virtual zero point, while the capacitor C2 effectuates the electrical isolation. Thus, the amplifier circuit operates within the most favorable range around 12 V, while the distance sensor supplies 0 V . . . 10 V.

One or more of these distance sensors can be integrated into a robot that is moved past several packaged articles. The evaluation unit 40, in conjunction with evaluation software, provides the robot with the requisite information about the contours of the packaged articles, so that these can be, for instance, gripped individually and transferred by the robot. Here, several packaged articles can be scanned horizontally or vertically. In the horizontal scanning direction, this is usually less critical since the packaged articles are not compressed by the force of gravity. Here, it is also possible for one or more distance sensors to be stationary, while the objects to be scanned are moved.

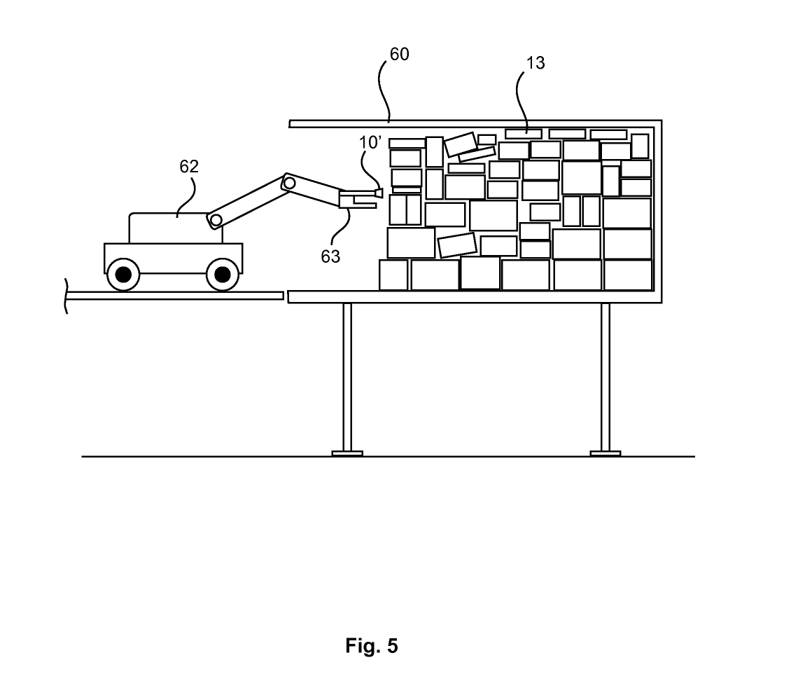

The application possibilities of the sensor system according to an exemplary embodiment of the invention will now be explained on the basis of several embodiments. In a first embodiment, which is shown in FIG. 5, the sensor system according to the invention is employed to carry out a vertical scanning pass along a stack of packaged articles including parcels. The stack of packaged articles here is located in a swap body 60 that has been parked on legs in front of a building. This is a typical scenario in the logistics realm and especially in postal operations, when many parcels 13 are stacked in a swap body 60 and have to be unloaded. Using a loading ramp, a parcel robot 62 can be moved in front of or, as the unloading progresses, into the swap body 60. The parcel robot 62 has an articulated arm with a gripper 63 that can be configured in different ways for purposes of gripping the parcels 13 individually and placing them, for instance, onto a conveyor belt (not shown in FIG. 5). The gripper 63 is only depicted schematically in FIG. 5, whereby it is preferably a suction gripper with which parcels can be picked up by the front.

At least one distance sensor 10′ according to an exemplary embodiment of the invention is installed on this gripper 63 and, through movements of the robot, said distance sensor 10′ can be moved along the front stack of packaged articles in a vertical plane. In this process, several scanning passes can be executed in the vertical as well as in the horizontal direction in order to scan the entire front surface of the stack. The scanning pass is done, for example, before the transfer process for the stack of parcels is initiated. If the gaps or edges between the parcels of the front stack were detected as a result of the assessment of the signals carried out by the evaluation unit(s) during the scanning pass and if they were evaluated by software, then the control unit of the robot has all of the requisite information about the position and the contours of the individual parcels. These parcels 13 can subsequently be picked up by the gripper 63 through targeted movements of the robot, and they can then transferred, for example, onto a conveyor belt.

It is, however, also possible for the front of the stack of parcels to be detected parallel to the transfer procedures or else only in certain areas of the stack in order to make the procedure altogether faster. For instance, the transfer procedure can start at the top of the stack, which calls for a scanning pass in the top area. Once the top parcels have been picked up and transferred, further scanning of gaps between the parcels can be dispensed with since all of the other layers can optionally be detected by other sensor equipment such as 3D laser scanners, on the basis of the upper edge, which has now been exposed. If this information is not sufficient to determine the position of a parcel, then the sensor system according to an exemplary embodiment of the invention can be employed instead of or in addition thereto.

In a second application example of the sensor system according to an exemplary embodiment of the invention, a scanning pass is carried out in the horizontal plane. In this case, the arrangement including at least one distance sensor and one evaluation circuit for detecting packaged articles on a pallet is employed. A typical pallet-unloading cell includes a chain conveyor that accommodates several pallets, temporarily stores them, conveys them one at a time to the operating area of a robot and subsequently stacks the empty pallets so that they can be hauled away.

The pallet-unloading robot removes the articles individually from the pallet and places them, for instance, onto a conveyor line. In the case of small-sized, flat goods, it is advantageous to pick them up with a suction gripper. In this context, an exemplary embodiment of the invention can be used to scan the top layer of the pallet using one or more distance sensors so as to detect gaps between the packaged articles. Once the evaluation unit has all of the information about the ascertained gaps and parcel edges, the robot with one or more suction grippers can be operated in such a manner that it picks up and transfers the detected packaged articles individually. However, it can also be provided for the pallet to be unloaded one layer at a time using a suction gripper that extends over the entire surface area of the pallet. In this case, several packaged articles are picked up and transferred simultaneously.

In both cases, the distance sensor system according to an exemplary embodiment of the invention can be employed to recognize paper interlayers on the pallet that have to be segregated. If there is such a paper interlayer on the top layer of the pallet, the distance sensor equipment will not detect any gaps on the surface and the evaluation software can consider this to indicate the presence of a paper interlayer. The paper interlayer can be picked up and discarded, for example, into a separate container.

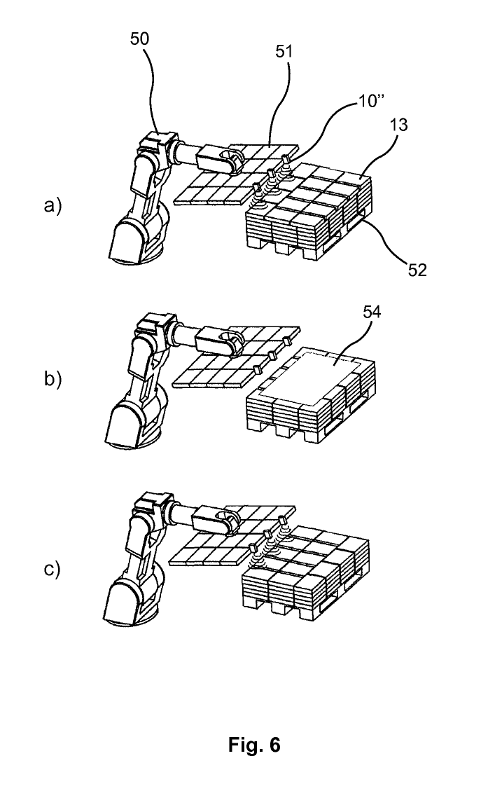

This procedure will be described below on the basis of FIG. 6 and of the situations a) through c) shown there. The pallet-unloading robot 50 has, for instance, a gripping arm with an attached suction gripper 51 for purposes of unloading packaged articles 13 from a pallet 52. The pallet-unloading robot 50, which lifts the packaged articles 13 off the pallet 52 one layer at time and places them onto a conveyor line, moves the appertaining gripping tool 51 above the pallet 52 on its way back anyway. If one or more laser distance sensors 10″ facing downwards have been installed on the side edge of the gripping tool 51, they scan the surface profile of the top pallet layer on the way back, as depicted in FIG. 6 for situation a). Here, a first stacking pattern is scanned in which a row with four packaged articles is arranged in front of two rows that each have five packaged articles. Since this stacking pattern contains only packaged articles, all of the distance sensors respond, and they detect edges or gaps as schematically depicted by responding sensors 10″.

If no abrupt jumps in distance can be detected in this stacking pattern or profile, but rather only gradual distance changes are noticeable (for example, waves in the paper interlayer), then conversely, the evaluation unit does not respond. Consequently, a paper interlayer is present under the sensors, as indicated in situation b) in FIG. 6. In contrast, likewise no paper interlayer is recognized in the second stacking pattern according to situation c) shown in FIG. 6, in which a row of four packaged articles is arranged behind two rows that each have five packaged articles.

Since a distance sensor only measures along one line, it will only be able to scan a certain area. However, the fact that a distance sensor has not detected any abrupt distance changes does not yet mean that there are no more goods on the interlayer at a different place of the pallet surface. This can be the case if the pallet was not unloaded precisely one layer at time. For this reason, it is advantageous to always employ several distance sensors so that a pallet layer can be examined as thoroughly as possible.

If all of the sensors have found at least one edge during a scanning pass, this probably means that there is a complete layer of packaged articles such as catalogs or cartons. If none or only a few sensors have responded, this indicates a paper interlayer or else a paper interlayer on which there are still a few goods, as depicted in FIG. 6 for a situation b).

If the objective is to prevent paper interlayers from reaching the conveying system, it can be provided that only complete layers of packaged articles for which all of the sensors have responded are placed onto the conveying system. All other results are treated as paper inter-layers.

The response of the electronic evaluation units of the distance sensors 10″ should therefore be temporarily stored in a memory unit so that the results can be evaluated at the end of the scanning pass. Then it is checked whether all of the sensors have responded or not. Such a memory unit can be implemented in the form of software in the control unit of the robot or else can be configured as an autonomous solution with a number of CMOS gates. In this case, the output signals of the evaluation units of the sensors are each transmitted to an RS flip-flop, whereby a flip-flop is set when a signal occurs. Their outputs are linked via a logical AND gate that then only supplies the defined value “high” if all of the flip-flops have been set. The value is queried at the end of the scanning pass. Immediately before the next scanning pass, the flip-flops are reset once again via a signal, for example, from the control unit of the robot, which then brings about the reset.

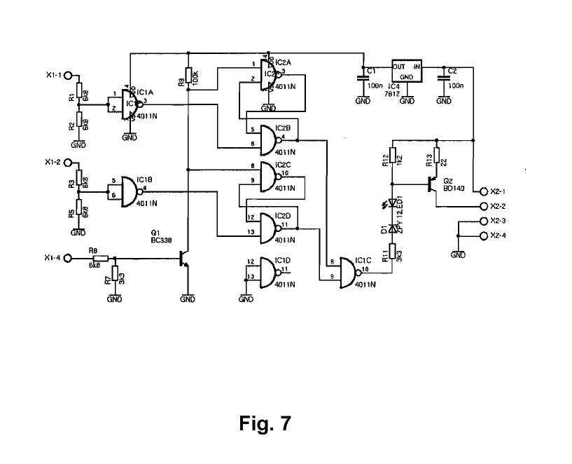

FIG. 7 shows such a circuit with CMOS gates of the type that can be employed for the described method. Two evaluation units of distance sensors according to an exemplary embodiment of the invention supply their output signals to the inputs X1-1 and X1-2, whereas X1-4 is the reset input. IC1A and IC1B are inverters, while IC2A/IC2B and IC2C/IC2D are connected as RS flip-flops. At its outputs, IC1C forms an AND gate with inversion (NAND gate) that only supplies “low” at the output if both inputs are “high”, in other words, if both flip-flops have been set. The “low” switches a PNP transistor Q2 so that a signal appears at a terminal X2-2.

X2-1 is the connection for the voltage supply, whereby the voltage regulator IC4 is needed since CMOS-ICs must not be operated directly with the industrial standard low voltage of 24 V.

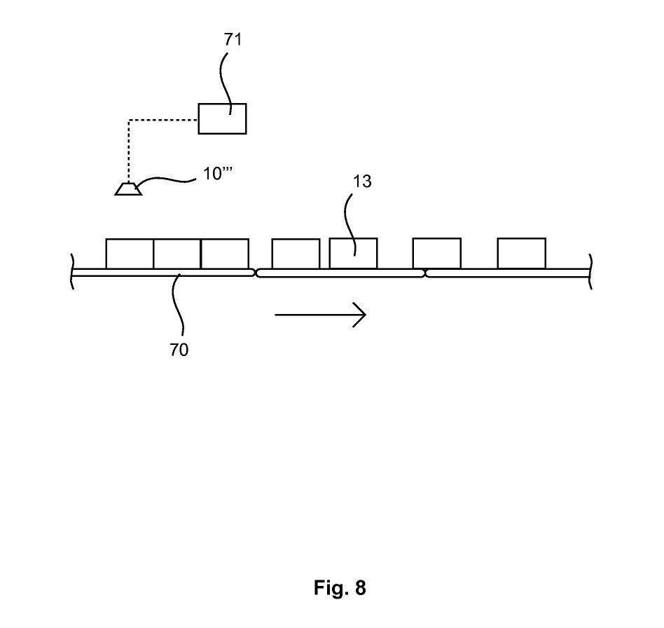

Another application case for a horizontal scanning direction is the segregation of objects as is needed, for instance, for packaged articles on conveyor lines. For example, parcels 13 are placed as packaged articles onto a conveyor line 70 and transported to a downstream processing station, as schematically shown in FIG. 8. Here, it can happen that several packaged articles are placed onto the conveyor belt at the same time or else, in the case of full capacity utilization or in the case of malfunctioning of the installation, a person might be working faster than the conveyor line. The parcels then lie without gaps on the conveyor belt so that the beginning and end of the individual items can no longer be ascertained by light-barrier arrays as it is the case for the parcels shown on the left-hand side of FIG. 8. Consequently, there is a need here for an automatic individuation of these parcels, which is made possible by an exemplary embodiment of the invention.

With the usual individuation in such conveyor lines, normally several partial conveyor segments are provided that are each driven at different speeds. The first partial conveyor segment runs, for example, slowly, while the subsequent partial segments run incrementally faster, so that a group of parcels can be pulled apart. At the end, a reflective barrier then checks whether there are gaps between the parcels. If a maximum length is exceeded, the installation signals a malfunction.

The individuation process can then be carried out intelligently with an exemplary embodiment of the invention and by the described arrangement including one or more distance sensors 10′″ in conjunction with an evaluation unit. The distance sensor(s) 10′″ is/are preferably arranged above or to the side of the conveyor 70, whereby, in contrast to the embodiment described so far, the distance sensors are stationary and face the packaged articles on the conveyor line. The associated evaluation unit reliably detects the boundaries between the parcels 13 as they pass by, whereby the evaluation unit is in communication with a conveyor line control unit 71. If the evaluation unit detects two parcels lying very close to each other, the feeding conveyor segment is briefly halted by the control unit 71 while the subsequent conveyor segment continues to run. The first article in each case thus continues to be conveyed, while the second article is delayed. In this manner, the individuation can be carried out reliably and the individuating segment can be configured to be shorter, mechanically simpler and thus more cost effective. Even the construction costs for the facilities can be reduced since the individuating segments fundamentally take up less space than conventional individuating segments.

What is claimed is:

1. A sensor system for detecting the surface structures of several packaged articles, comprising:
at least one laser distance detector that functions according to a triangulation principle and that determines distance between the at least one laser distance detector and a surface structure of a packaged article, whereby the laser distance detector has at least one analog output via which a distance-proportional analog signal can be emitted; and
an amplifier circuit that provides communication between an analog output of the at least one laser distance detector and an evaluation unit, the amplifier circuit encompassing at least one operational amplifier that has two inputs, the analog signal of the laser distance detector being present at a first input of the at least one operational amplifier, while a variable reference voltage is present at the other input of the at least one operational amplifier, the reference voltage being obtained from the analog signal of the analog output, and this analog signal being present at the other input of the operational amplifier via a low-pass filter, the output of the at least one operational amplifier being connected to the evaluation unit, the amplifier circuit being configured so that abrupt changes in the analog signal bring about a change in the output signal of the at least one operational amplifier, whereas relatively gradual changes in the analog signal do not bring about substantial change in the output signal of the at least one operational amplifier, the evaluation unit evaluating the output signal of the at least one operational amplifier.

2. The sensor system recited in claim 1, wherein the amplifier circuit comprises a first operational amplifier and a second operational amplifier that are connected in parallel, the analog signal of the at least one laser distance detector being present at the first input of the first operational amplifier and at the first input of the second operational amplifier, the variable reference voltage being present at the other input of the first operational amplifier and at the other input of the second operational amplifier, the outputs of the two operational amplifiers being connected to the evaluation unit via an OR gate.

3. The sensor system recited in claim 1, wherein a virtual zero point of the amplifier circuit is raised in such a way that the amplifier circuit operates in a voltage range that differs from that of the at least one laser distance detector.

4. The sensor system recited in claim 1, wherein the sensor system is installed on a gripping tool of a robot, the robot being configured to move the sensor system along the surface of at least one packaged article, the sensor system being in communication with a robot control unit that evaluates the output signals of the amplifier circuit and controls the robot.

5. The sensor system recited in claim 4, wherein the sensor system is installed on the gripping tool of a pallet-unloading robot, the sensor system comprising several laser distance sensors, the robot control unit being configured to move the sensor system in a horizontal plane along the surface of at least one packaged article.

6. The sensor system recited in claim 5, the robot control unit comprising a memory unit, each analog output of a laser distance sensor being connected to the memory unit via an amplifier circuit, the memory unit comprising a plurality of RS flip-flops, each output signal of an amplifier circuit being present at an individual one of the plurality of RS flip-flops, the outputs of the plurality of RS flip-flops being linked to each other via an AND gate that supplies a defined value when all of the plurality of RS flip-flops are set, the defined value being evaluated by the robot control unit, the robot control unit comprising a reset device that resets all of the plurality of RS flip-flops.

7. The sensor system recited in claim 6, wherein the robot control unit comprises an actuator that actuates placement of a paper interlayer at a defined position when the AND gate does not supply the defined value.

8. The sensor system recited in claim 4, the sensor system being installed on a gripping tool of a parcel robot, a control unit of the parcel robot being adapted to move the sensor system in a vertical plane along the surface of several parcels in a stack.

9. The sensor system recited in claim 8, the sensor system, in addition to at least one 3D laser scanner and an image processing device, being installed on a parcel robot, the control unit of the robot selecting the sensor system and the 3D laser scanner, as needed.

10. The sensor system recited in claim 1, the sensor system being installed above or to the side of a conveyor line for packaged articles, the conveyor line comprising at least two separately driven segments, the sensor system being in communication with a control unit of the conveyor line with which the speed of the segments can be controlled separately.
